(19) United States
(12) Patent Application Publication
(10) Pub. No.: US 2013/0073321 A1
(43) Pub. Date: Mar. 21, 2013

(54) SYSTEMS AND METHODS FOR GENERATING VEHICLE INSURANCE PREMIUM QUOTES BASED ON A VEHICLE HISTORY

(71) Applicants: Glenn Hofmann, Chicago, IL (US); Christopher Maydak, Plainfield, IL (US); Adam Pichon, Milton, GA (US); Jeffrey Reynolds, Winnetka, IL (US)

(72) Inventors: Glenn Hofmann, Chicago, IL (US); Christopher Maydak, Plainfield, IL (US); Adam Pichon, Milton, GA (US); Jeffrey Reynolds, Winnetka, IL (US)

(73) Assignee: TRANS UNION LLC, Chicago, IL (US)

(21) Appl. No.: 13/589,033

(22) Filed: Aug. 17, 2012

Related U.S. Application Data
(60) Provisional application No. 61/524,344, filed on Aug. 17, 2011.

(51) Int. Cl. G06Q 40/08

(52) U.S. Cl. 705/4

(57) ABSTRACT

A method is provided for generating an insurance premium quote for a consumer seeking insurance coverage for a vehicle. The method determines a vehicle score indicative of a likelihood of a future auto insurance claim for the vehicle, wherein the vehicle score is based on both VIN based data and historical data of the vehicle. The method determines an insurance score for the consumer, based on at least one of a credit score, a driving record and a claim record. The method further generates the insurance premium quote based on the determined vehicle score and the insurance score.

### CROSS-REFERENCE TO RELATED APPLICATION

This application claims priority to U.S. Provisional Application No. 61/524,344, filed Aug. 17, 2011, entitled “SYSTEMS AND METHODS FOR GENERATING VEHICLE INSURANCE PREMIUM QUOTES BASED ON A VEHICLE HISTORY”, and is incorporated herein by reference in its entirety.

### TECHNICAL FIELD

This invention generally relates to the insurance industry, and more particularly to systems and methods for generating vehicle insurance premium quotes based on a vehicle history.

### BACKGROUND

An auto insurance vehicle rating is used to calculate policy premiums. Typically, ratings for specific make and model vehicles can be looked up in industry publications such as an annual publication provided by the Insurance Services office (ISO). The purpose of vehicle ratings is to match premiums for each particular type of vehicle to losses for that type of vehicle. For each vehicle series, defined by such characteristics as make, model, body style, and wheelbase, the vehicle ratings may be used by insurers to determine premiums for individual policies. Car loss history, the amount a car costs to replace or repair and how often it is stolen, are some of the main factors in determining the vehicle rating. A vehicle with a higher rating will have a higher premium than a vehicle with a lower rating, if all other rating variables are the same. These auto insurance vehicle ratings are only used for the purpose of calculating a premium on collision and comprehensive coverage.

Policy premiums, determined by insurance carriers, should accurately reflect the risks insured against, so that they can offer competitively priced yet profitable policies. Thus, policy premium determination, based on proper risk evaluation, is critical for such insurance carriers. The policy premium determination depends upon the data forming the basis for the evaluation, which typically is based on driving records, credit records of the drivers, and the aforementioned vehicle ratings. However, this typical policy premium determination does not take into account the history or past of the particular vehicle the driver or consumer seeks to insure.

Therefore, there is a need for an improved insurance quoting system and method that integrates a vehicle specific history in the policy premium determination to accurately reflect the risks insured against, thereby minimizing losses by insurance carriers.

### SUMMARY

The invention is defined by the appended claims. This description summarizes aspects of exemplary embodiments and should not be used to limit the claims.

The invention is intended to, among other things, solve the above-noted business and technical problems by providing systems and methods for generating an insurance premium quote for a consumer seeking insurance coverage for a vehicle. In an embodiment, a method determines a vehicle score indicative of a likelihood of a future auto insurance claim for the vehicle, wherein the vehicle score is based on both VIN based data and historical data of the vehicle. An insurance score is determined for the consumer, based on at least one of a credit score, a driving record and a claim record. An insurance premium quote is generated based on the determined vehicle score and the insurance score.

According to another aspect, a non-transitory computer-readable medium comprising computer-readable instructions for generating an insurance premium quote for a consumer seeking insurance coverage for a vehicle is provided. The non-transitory computer-readable instructions, when executed by a computer, cause the computer to perform the method steps discussed above.

### BRIEF DESCRIPTION OF THE DRAWINGS

For a better understanding of the invention, reference may be had to preferred embodiments shown in the following drawings in which:

FIG. 1 is a block diagram of one form of a computer or server of FIG. 1, having a memory element with a computer readable medium for implementing the computing system used for collecting and processing vehicle and consumer information in accordance with a particular embodiment of the invention.

FIG. 2 is a block diagram illustrating a networked computing system for collecting and processing vehicle information and driving records for consumers seeking vehicle insurance quotes in accordance with a particular embodiment of the invention;

FIG. 3 is a block diagram illustrating an embodiment of a policy premium inquiry process in accordance with a particular embodiment of the invention;

FIG. 4 is a block diagram illustrating an embodiment of a process of combining vehicle identification data and vehicle history data to generate a vehicle score in accordance with a particular embodiment of the invention;

FIG. 5 is a block diagram illustrating an embodiment of a consumer record inquiry in accordance with a particular embodiment of the invention;

FIG. 6 is a block diagram illustrating an embodiment of a process of combining a vehicle score and a consumer's credit and driving history to generate a quote for an insurance policy premium in accordance with a particular embodiment of the invention;

FIG. 7 is a flow diagram illustrating an embodiment of a process of generating and combining a vehicle score and a consumer's credit and driving history to generate a quote for an insurance policy premium in accordance with a particular embodiment of the invention.

### DETAILED DESCRIPTION OF EXEMPLARY EMBODIMENTS

The invention is defined by the appended claims. This description summarizes aspects of exemplary embodiments and should not be used to limit the claims.

While the invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality.

In particular, a reference to “the” object or “a” and “an” object is intended to denote also one of a possible plurality of such objects.

In accordance with principles of the invention, systems and methods are provided for generating vehicle insurance premium quotes based on a vehicle history, which helps auto insurance carriers more accurately predict the likelihood of a vehicle insurance claim.

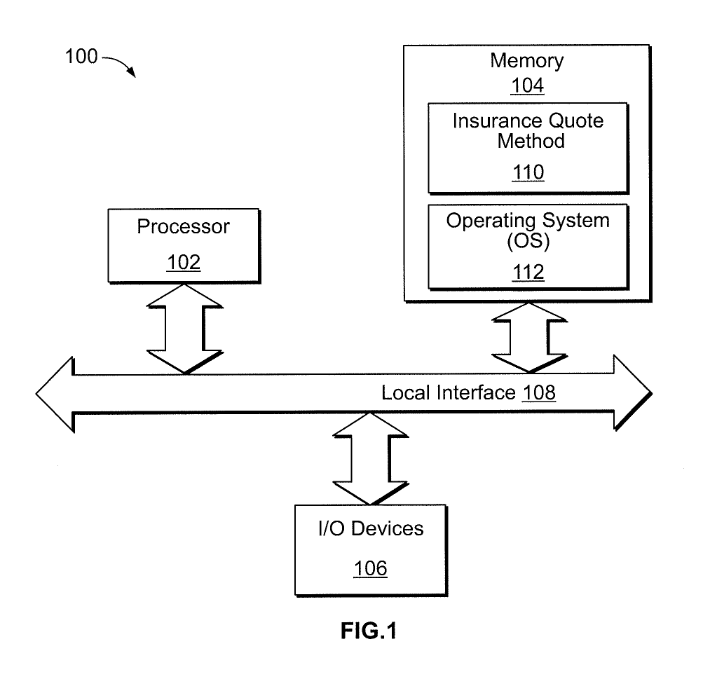

FIG. 1 is a block diagram of a computer 100. The computer 100 may be any one of the user computer 202, or any computer associated with the networked system 200. Without loss of generality and as an exemplary computer, the credit sever 204 is discussed hereafter. The computer 100 may include a memory element 104. The memory element 104 may include a computer readable medium for implementing the method 110 for improving insurance quotes.

The invention 110 may be implemented in software, firmware, hardware, or any combination thereof. For example, in one mode, a method 110 is implemented in software, as an executable program, and is executed by one or more special or general purpose digital computer(s), such as a personal computer (PC; IBM-compatible, Apple-compatible, or otherwise), personal digital assistant, workstation, minicomputer, mainframe computer, computer network, “virtual network” or “internet cloud computing facility”. Therefore, computer 100 may be representative of any computer in which the method 110 resides or partially resides.

Generally, in terms of hardware architecture, as shown in FIG. 1, the computer 100 includes a processor 102, memory 104, and one or more input and/or output (I/O) devices 106 (or peripherals) that are communicatively coupled via a local interface 108. The local interface 108 may be, for example, but is not limited to, one or more buses or other wired or wireless connections, as is known in the art. The local interface 108 may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor 102 is a hardware device for executing software, particularly software stored in memory 104. Processor 102 can be any custom made or commercially available processor, a central processing unit (CPU), an auxiliary processor among several processors associated with the computer 100, a semiconductor based microprocessor (in the form of a microchip or chip set), another type of microprocessor, or generally any device for executing software instructions. Processor 102 may also represent a distributed processing architecture such as, but not limited to, SQL, Smalltalk, APL, KLisp, Snobol, Developer 200, MUMPS/Magic.

Memory 104 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 1104 may incorporate electronic, magnetic, optical, and/or other types of storage media. Memory 104 can have a distributed architecture where various components are situated remote from one another, but are still accessed by processor 102.

The software in memory 104 may include one or more separate programs. The separate programs comprise ordered listings of executable instructions for implementing logical functions, which may include one or more code segments or portions. In the example of FIG. 1, the software in memory 104 includes the method 110 in accordance with a particular aspect, a suitable operating system (O/S) 112. A non-exhaustive list of examples of suitable commercially available operating systems 112 is as follows: (a) a Windows operating system available from Microsoft Corporation; (b) a Netware operating system available from Novell, Inc.; (c) a Macintosh operating system available from Apple Computer, Inc.; (d) a UNIX operating system; (e) a LINUX operating system, which is freeware that is readily available on the Internet; (f) a run time Vxworks operating system from WindRiver Systems, Inc.; or (g) an appliance-based operating system, such as that implemented in handheld computers, smartphones, or personal digital assistants (PDAs). The operating system essentially controls the execution of other computer programs, such as the method 110, and provides scheduling, input-output control, file and data management, memory management, and communication control and related services.

The method 110 may be a source program, executable program (object code), script, or any other entity comprising a set of instructions to be performed. When a “source” program, the program needs to be translated via a compiler, assembler, interpreter, or the like, which may or may not be included within the memory 104, so as to operate properly in connection with the O/S 112. Furthermore, the platform system 110 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, .Net, HTML, and Ada.

The I/O devices 106 may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices 106 may also include output devices, for example but not limited to, output modules for PLCs, a printer, bar code printers, displays, etc. Finally, the I/O devices 106 may further comprise devices that communicate with both inputs and outputs, including, but not limited to, a modulator/demodulator (modem; for accessing another device, system, or network), a radio frequency (RF) or other transceiver, a telephonic interface, a bridge, and a router.

If the computer 100 is a PC, workstation, PDA, or the like, the software in the memory 104 may further include a basic input output system (BIOS) (not shown in FIG. 4). The BIOS is a set of essential software routines that initialize and test hardware at startup, start the O/S 112, and support the transfer of data among the hardware devices. The BIOS is stored in ROM so that the BIOS can be executed when computer 100 is activated.

When computer 100 is in operation, processor 102 is configured to execute software stored within memory 1104, to communicate data to and from memory 104, and to generally control operations of computer 100 pursuant to the software. The method 110, and the O/S 112, in whole or in part, but typically the latter, may be read by processor 102, buffered within the processor 102, and then executed.

When the method 110 is implemented in software, as is shown in FIG. 1, it should be noted that the method 110 can be stored on any computer readable medium for use by or in connection with any computer related system or method, although in one preferred embodiment, the method 110 is implemented in a centralized application service provider arrangement. In the context of this document, a computer readable medium is an electronic, magnetic, optical, or other physical device or means that can contain or store a computer program for use by or in connection with a computer related system or method. The method 110 can be embodied in any type of computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” may be any means that can store, communicate, propagate, or transport the program for use by or in connection with the instruction execution system, apparatus, or device. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, where the method 110 is implemented in hardware, the method 110 may also be implemented with any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

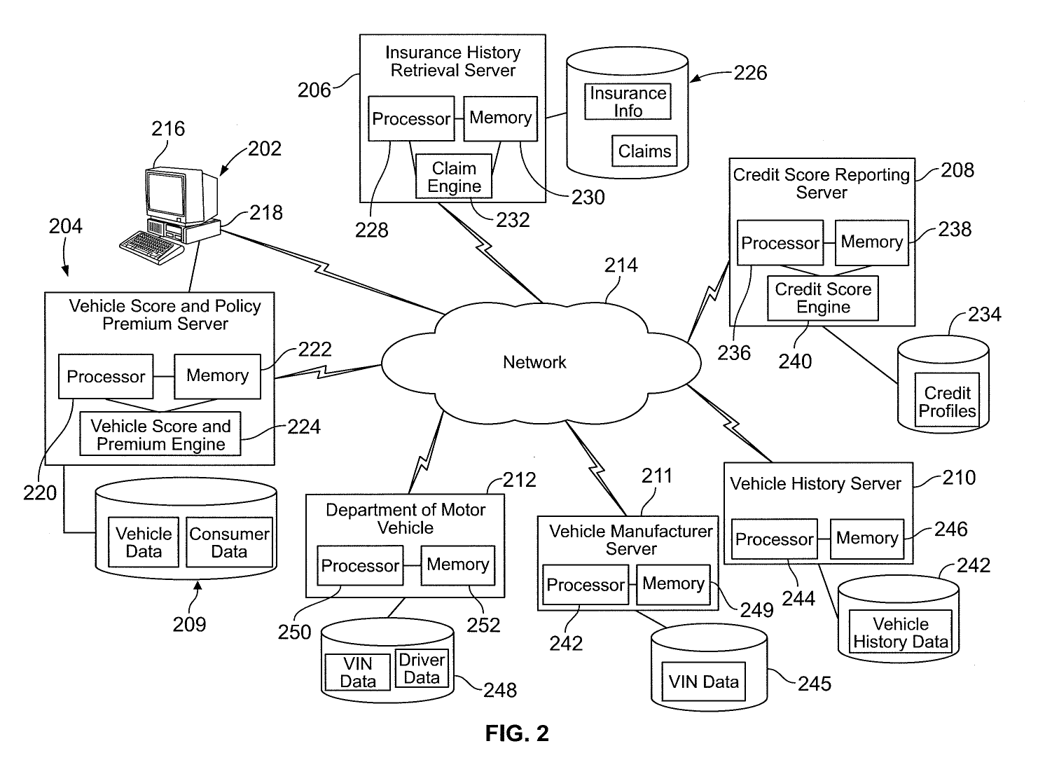

Now referring to FIG. 2, a networked system 200 for collecting and processing vehicle model and individual history, and credit and claim information associated with consumers seeking insurance quotes is shown in accordance with a particular embodiment of the invention. In the embodiment of FIG. 2, the networked system 200 comprises a user computer 202 and a server 204, both communicatively connected to at least one insurance history retrieval server 206, at least one credit score reporting server 208, at least one vehicle history server 210, one vehicle manufacturer server 211, and at least one department of motor vehicle (DMV) server 212 through a network 214 (e.g. the Internet). The user computer 202 is coupled to a vehicle and consumer database 209, and may include a computer monitor 216 and a desktop processing unit 218. The server 204 may include a processor unit 220, a memory unit 222 and a vehicle score and policy premium engine unit 224. The insurance history server 206 is coupled to insurance database 226, and may also include a processor unit 228, a memory unit 230 and a claim engine 232. The credit score reporting server 208 is coupled to a credit profile database 234, and may include a processor unit 236, a memory unit 238 and a credit score engine 240. The vehicle history server 210 is coupled to a vehicle history database 242, and may include a processor unit 244 and a memory unit 246. The vehicle manufacturer server 211 is coupled to a vehicle identification number (VIN) database 245, and may include a processor unit 247 and a memory unit 249. The DMV server 212 is coupled to a vehicle and driver database 248, and may include a processor unit 250 and a memory unit 252.

The user computer 202 and the server 204 may be connected through a local area network (LAN). Alternatively, the user computer 202 and the server 204 may be communicatively coupled to one another via a global network or a wide area network (WAN). Further, the user computer 202, which is shown as a personal computer, may be a handheld or a portable computing device. The server 204 preferably includes a plurality of programs, including but not limited to programs stored within the memory unit 222 for receiving and processing queries transmitted from the user computer 202 electronically. Similarly, each of the insurance history server 206, credit score reporting server 208, vehicle history server 210, vehicle manufacturer server 11, and DMV server 212 preferably includes a plurality of programs, including but not limited to programs stored within memory units 230, 238, 246, 249, and 252, respectively, for receiving and processing queries transmitted from the user computer 202 and the server 104 electronically. In certain preferred embodiments, the electronic transmission between the servers 206-212 and either the user computer 202 or the server 204 may occur through File Transfer Protocol (“FTP”) or Internet Transfer Protocol (“TCP/IP”) or others.

In one embodiment, the server 204 is associated with an insurance carrier, and the database 209 is configured to maintain credit, driving and vehicle insurance claim information on consumers, received from databases 226 and 234, and vehicle information received from databases 242, 245 and 248. Alternately, the server 204 may be associated with a credit record reporting office or bureau, such as server 208. The server 206 is associated with an insurance history information retrieval business, and the database 226 is configured to maintain insurance loss histories and other behavior information for individual consumers. The insurance loss histories are typically captured in the form of claims filed by consumers.

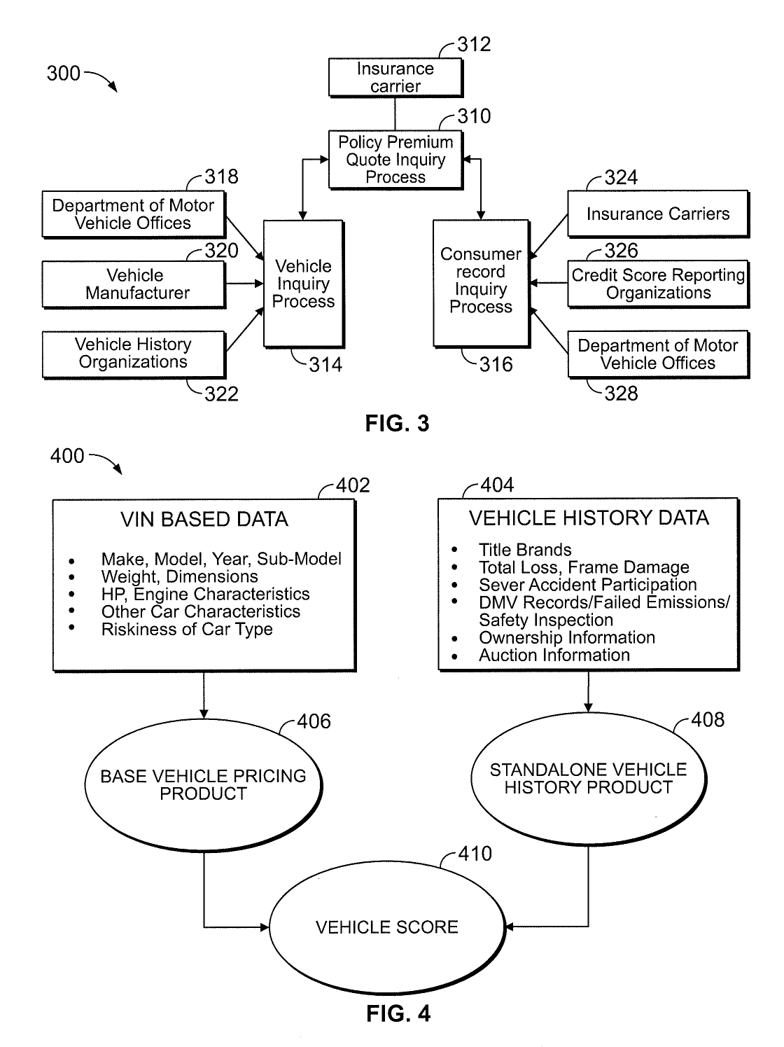

As illustrated in FIG. 3, an inquiry 310 instigated by an insurance carrier 312, in response to a consumer desiring an insurance quote for a particular vehicle, can spawn a vehicle inquiry process 314 and a consumer record inquiry process 316. The vehicle inquiry process 314 attempts to generate a vehicle score based on the vehicle VIN-based data provided by the vehicle manufacturer 318, the particular vehicle history information available from a plurality of the DMV offices 320 associated with the plurality of cities or states where the vehicle had been registered and provided corresponding license plates, and from organizations 322 that specialize in collecting historical vehicle data, such as CARFAX®. The consumer record inquiry process 316 attempts to generate a consumer record based on an insurance claim history provided by a plurality of insurance carriers 324 having historically provided vehicle insurance coverage to the consumer, on credit scores provided by a plurality of credit score reporting organizations or bureaus 326, and on driving records provided by a plurality of DMV offices 328 associated historical residences of the inquiring consumer.

Referring to FIGS. 3 and 4, upon initiation of the vehicle inquiry process 314, the vehicle and premium engine 224 is operative to acquire VIN data and historical data associated with the particular vehicle from databases 242, 245, and 248 associated with at least one vehicle history server 210, 320, a corresponding manufacturer server 211, 318, and at least one DMV office server 212, 316. Each vehicle sold within most countries, including the United States, has a unique VIN which is typically listed on the issued vehicle title, affixed on the vehicle itself, such as on the dashboard, and/or engraved on the engine/motor. The VIN is thus essential to identifying and tracing the public record of a particular vehicle and associating historical data collected from a variety of sources for the particular vehicle. As such, hereafter, a reference to “the particular vehicle” implies a reference to one and only one vehicle associated with one VIN, and not to the generic make/model/year of the vehicle. As shown in Block 402 of FIG. 4, the VIN based data includes make, model, year, sub-model information, weight and dimensions, horsepower, engine characteristics. Moreover, in some instances, the VIN data may further includes riskiness of the vehicle type. As shown in Block 404 of FIG. 4, the historical data of the particular vehicle includes title and registration information, DMV records, auction and sale records, accident information, mileage information, ownership information, recall information and any other information pertinent to the history of the particular vehicle. The title and registration information may include state registration, taxi registration, commercial registration and fleet registration. The accident information may include police accident reports and damage information, fire damage information, flood damage information, salvage and/or junk title information. The mileage information may include mileage history and odometer issues. The DMV records may include safety inspection information and emissions issues. The ownership information may include the number of owners and corresponding length of ownership. The ownership information can typically be determined from the number of title/registration records issued for the particular vehicle. However, the vehicle score and policy premium engine 224 is also operative to recognize when a title/registration record is the result of the owner of the particular vehicle moving to another state, which leads to the issuance of another title/registration. This historical information of the particular vehicle is stored in the database 209 and is associated with its unique VIN.

Still referring to FIG. 4, upon collection of the VIN based data 402 of a plurality of vehicles, the vehicle and premium engine unit 224 is operative to generate a base vehicle pricing 406. This base vehicle pricing 406 is developed on a large diverse vehicle dataset using pricing techniques, such as multivariate data analysis (MVA) to include interactions with other rating variables, including insurance scores. Additionally, rating factors for vehicles can be generated on a coverage level basis for improved pricing accuracy. This base vehicle pricing 406 serves to improve vehicle pricing. Upon collection of the vehicle history data 404, the vehicle and premium engine unit 224 is operative to generate a standalone vehicle history 408 for each particular vehicle, which helps develop a pricing segmentation of vehicles which can be used in underwriting or added to an existing rating plan of vehicles. The standalone vehicle history 408 can help capture increased propensity of branded title events, previous sever damage, high mileage history, potential vehicle problems and ownership history, as well as focus on better expected loss results for vehicles with positive ownership histories. Based on the developed base vehicle pricing 406 and standalone vehicle history 408, the vehicle and premium engine unit 224 is operative to generate a vehicle history score 410 for the particular vehicle that provides a risk evaluation improvement over the standard vehicle rating utilized by insurance carriers, which does not include the particular vehicle's history but is solely based on the value of the particular vehicle and its model's safety ratings and theft data.

Based on the above discussion, the vehicle history score 410 can be generated based on a plurality of vehicle variables, including but not limited to:
Variable 1, which relates to the number of owners and length of recent ownership, which is a concatenation of two elements, the number of prior owners (including the current owner) combined with the length of ownership for the current owner.
Variable 2, which relates to severe accident/potential damage. This variable examines accident indicators and potential damage indicators provided by a vehicle history collection organization, such as CARFAX.
Variable 3, which relates to a commercial use indicator.
Variable 4, which relates to a fleet/rental indicator.
Variable 5, which relates to a lease vehicle indicator.
Variable 6, which relates to odometer problems, such as inconsistent odometer readings, verified odometer rollbacks.
Variable 7, which relates to a stolen vehicle indicator.
Variable 8, which relates to a flag which may indicate severe problem vehicle components.

The vehicle score 410 is a vehicle rating that serves to help insurance carriers more accurately predict the likelihood of an auto insurance claim for the particular vehicle, and, in the event of a claim, predict the severity of the claim. Thus, the vehicle score 410 is a reflection of the likelihood for a future claim event. In one embodiment, for the evaluation of the vehicle score 410, each of these 8 variables is assigned a weight based on the applicability or occurrence of the variable to the particular vehicle, and added to a base number. In one practical example, with weights ranging from a value of zero (0) to a value of hundred (100), variables 3, 4, and 6 may have weights, 60, 47 and 23, respectively, while the other variables have weights equal to zero, and the base number is chosen to be equal to 100. As such, this exemplary vehicle history score 410 is equal to the base number value of 100 augmented by the weights of the three non-zero variables 3, 4, and 6. That is, this exemplary vehicle score 410 is equal to 330. Accordingly, the higher the vehicle score 410 the higher the likelihood of a future severe claim event for the particular vehicle. Moreover, the variable weights may vary by vehicle version and by state. As such, the evaluation of the vehicle score 410 can be adjusted to the vehicle version and state by varying or assigning various weights to the variables.

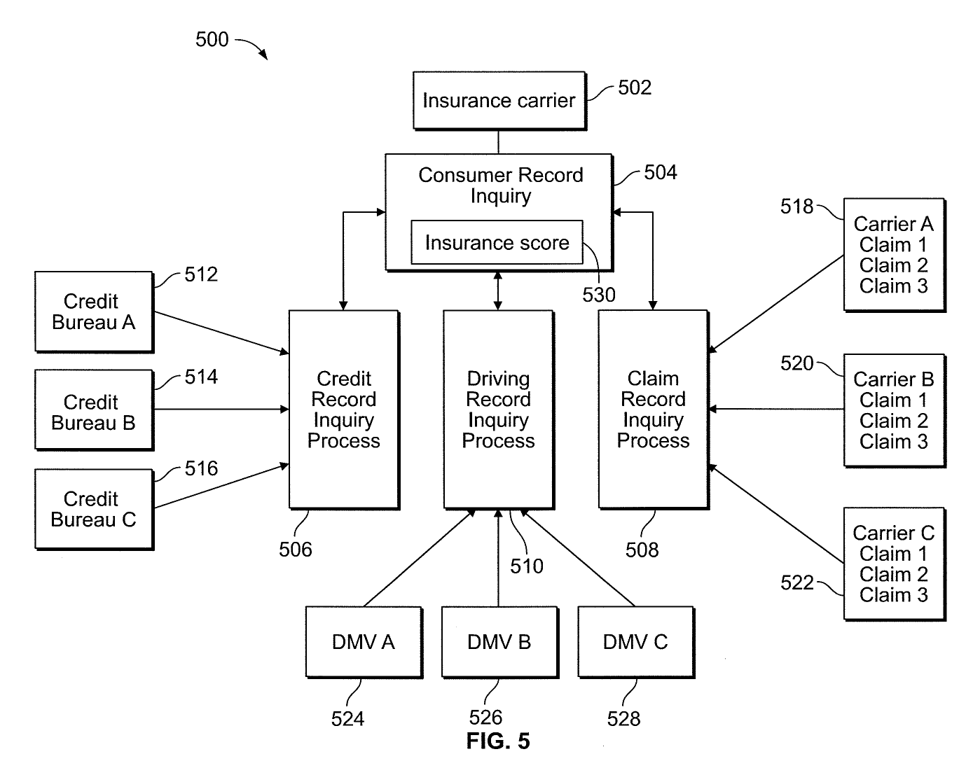

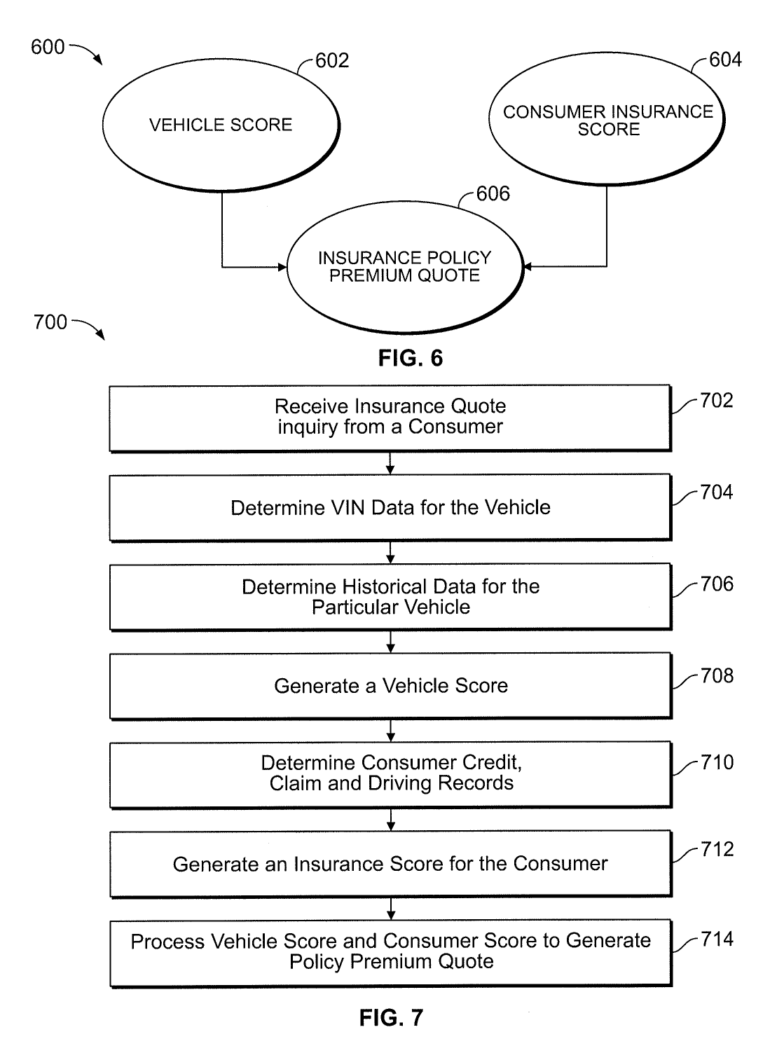

As illustrated in FIG. 5, a consumer record inquiry 504 instigated by a carrier 502 can spawn a credit record inquiry process 506, a claim record inquiry process 508, and a driving record inquiry process 510. The credit record inquiry process 506 attempts to obtain a credit record from at least one credit score reporting server 208 associated with one the plurality of credit bureaus A-C, 412-416. The claim record inquiry process 408 attempts to establish a claim history of the consumer by accessing at least one insurance history retrieval server 206 associated with one of the plurality of insurance carriers A-C, 518-522. The driving record inquiry process 510 attempts to establish a driving history of the consumer by accessing at least one DMV server 212 associated with one of the plurality of state DMVs A-C, 524-528. Based on the results of these inquiries 506-510, the vehicle and policy engine unit 220 is operative to process the credit, driving and claim records to generate a consumer or insurance score 530, which can help an insurance carrier to underwrite the consumer at a cost that most accurately reflects the consumer's specific risk. The consumer insurance 530 may also take into account additional variables, such as where and how much the consumer drives as well as his/her age, sex, and marital status. As such, when determining a potential policy rate or premium, the generated consumer insurance score 530 can be a more informative and immediately usable piece of data for an insurance quoting process. Now referring to FIG. 6, once the vehicle score 410, 602 and the consumer insurance score 510, 604 have been generated, the vehicle and premium engine 224 is operative to combine them to generate a policy premium quote 606, which is indicative of an improved prediction of the likelihood of an insurance loss based on the particular vehicle's historical data.

Now referring to FIG. 7, a flow chart illustrates an embodiment 700 of a method for generating a policy premium quote for a consumer based on processed vehicle VIN data, vehicle historical data, and the consumer's credit, claim, and driving records in accordance with a particular aspect. Upon receiving a policy premium inquiry consumer for a particular vehicle, generated by a consumer, from a program associated with or residing in either an insurance carrier server or the insurance history information retrieval business server 206, at Step 702, by a program residing in or associated with the vehicle and premium server 204, a first determination is made as to the VIN data of the particular vehicle, at Step 704, and a second determination is made as to the vehicle history of the particular vehicle, at Step 706. Upon their determination, these two VIN and history data are processed to generate a unique vehicle score, indicative of a prediction of a future insurance loss for this particular vehicle, at Step 708. Concurrently, the credit, car insurance claim, and driving records associated with the consumer seeking the vehicle insurance premium quote are determined, at Step 710, to generate an insurance score for the consumer, at Step 712. Subsequently, at Step 714, the vehicle and premium engine 224 determines the requested policy premium quote based on the generated vehicle and insurance scores.

Although exemplary embodiments of the invention have been described in detail above, those skilled in the art will readily appreciate that many additional modifications are possible in the exemplary embodiment without materially departing from the novel teachings and advantages of the invention. Accordingly, these and all such modifications are intended to be included within the scope of this invention.

We claim:

1. A method for generating an insurance premium quote for a consumer seeking insurance coverage for a vehicle using a computer, comprising:
determining at the computer a vehicle history score indicative of a likelihood of a future auto insurance claim for the vehicle, wherein the vehicle score is based on both VIN based data and historical data of the vehicle;
determining at the computer an insurance score for the consumer, based on at least one of a credit score, a driving record and a claim record; and
generating at the computer the insurance premium quote based on the determined vehicle score and the insurance score.

2. The method of claim 1 wherein the VIN based data comprises at least one of make, model, year, sub-model information, weight and dimensions, horsepower, engine characteristics, and riskiness of the vehicle type.

3. The method of claim 1 wherein the historical data comprises at least one of title and registration information, DMV records, auction and sale records, accident information, mileage information, ownership information, and recall information.

4. The method of claim 1 wherein the vehicle history score is generated using a plurality of the following evaluation variables: number of previous owners, length of recent ownership, accident or damage indicators, commercial use indicators, fleet/rental status indicators, odometer problem indicators, stolen vehicle indicators, and vehicle component failure indicators.

5. The method of claim 4 wherein the vehicle history score is generated by assigning a weight to each evaluation variable.

6. The method of claim 5 wherein the weights assigned to the evaluation variables sums to 100.

7. The method of claim 1 further comprising the step of determining a base vehicle pricing for the vehicle.

8. The method of claim 7 wherein the base vehicle pricing is determined using multivariate data analysis of a large and diverse vehicle dataset.

9. The method of claim 1 further comprising the step of generating a standalone vehicle history for the vehicle.

10. The method of claim 9 wherein the standalone vehicle history is derived from the historical data of the vehicle.

11. A non-transitory computer readable medium comprising:
a first code segment configured to determine a vehicle history score indicative of a likelihood of a future auto insurance claim for a vehicle, wherein the vehicle score is based on both VIN based data and historical data of the vehicle;
a second code segment configured to determine an insurance score for the vehicle's owner, based on at least one of a credit score, a driving record and a claim record; and
a third code segment configured to generate an insurance premium quote for the owner based on the determined vehicle score and the insurance score.

12. The method of claim 11 wherein the VIN based data comprises at least one of make, model, year, sub-model information, weight and dimensions, horsepower, engine characteristics, and riskiness of the vehicle type.

13. The method of claim 11 wherein the historical data comprises at least one of title and registration information, DMV records, auction and sale records, accident information, mileage information, ownership information, and recall information.

14. The method of claim 11 wherein the vehicle history score is generated using a plurality of the following evaluation variables: number of previous owners, length of recent ownership, accident or damage indicators, commercial use indicators, fleet/rental status indicators, odometer problem indicators, stolen vehicle indicators, and vehicle component failure indicators.

15. The method of claim 14 wherein the vehicle history score is generated by assigning a weight to each evaluation variable.

16. The method of claim 15 wherein the sum of the weights assigned to the evaluation variables is 100.

17. The method of claim 11 further comprising a fourth code segment configured to determine a base vehicle pricing for the vehicle.

18. The method of claim 17 wherein the base vehicle pricing is determined using multivariate data analysis of a large and diverse vehicle dataset.

19. The method of claim 11 further comprising a fifth code segment configured to generate a standalone vehicle history for the vehicle.

20. The method of claim 19 wherein the standalone vehicle history is derived from the historical data of the vehicle.

21. A system for generating an insurance premium quote for a consumer seeking insurance coverage for a vehicle, comprising:
a processor; and
a memory configured to receive data from at least one remote source;
wherein the memory is configured to determine a vehicle history score indicative of a likelihood of a future auto insurance claim for the vehicle, based on both VIN based data and historical data of the vehicle;
determine an insurance score for the consumer, based on at least one of a credit score, a driving record and a claim record; and
generate the insurance premium quote based on the determined vehicle score and the insurance score.
